(19) United States
(12) Patent Application Publication
(10) Pub. No.: US 2008/0080836 A1
(43) Pub. Date: Apr. 3, 2008

(54) Video content recording apparatus with electronic program guide functionality

(76) Inventor: Matthijs C. Hutten, Redwood City, CA (US)

Correspondence Address: BRINKS HOFER GILSON & LIONE/SanDisk, P.O. BOX 10395, CHICAGO, IL, 60610, US

(21) Appl. No.: 11/540,122

(22) Filed: Sep. 29, 2006

(51) Int. Cl. H04N 5/91

(52) U.S. Cl. 386/83

(57) ABSTRACT

A video content recording apparatus with electronic program guide functionality is disclosed. In one embodiment, a video content recording apparatus is disclosed comprising circuitry operative to receive electronic program guide data; operative to display, on a display device, an electronic program guide that uses the electronic program guide data; and operative to record, onto a removable memory device, video content selected using the electronic program guide. The electronic program guide data can be received from a removable memory device. In another embodiment, a video content recording apparatus is disclosed comprising circuitry operative to receive a scheduled recording file from a removable memory device and further operative to record, onto a removable memory device, video content specified in a scheduled recording file. Other embodiments are disclosed, and each of the embodiments can be used alone or together in combination.

### BACKGROUND

In the past decade, advances have been made to provide consumers with enhanced control over the timing of video content recording and playback. For example, digital video recorders (“DVRs”) allow consumers to more easily record video content, as compared to using a video cassette recorder (“VCR”), and allow consumers to playback the video content whenever they like—even during the recording of the video content. Because most DVRs use a hard drive to store video content, the stored video content is often “tied” to the display device (e.g., television) connected to the DVR, restricting where the consumer can playback the video content. Devices are available that record video content onto a removable memory card. Once the video content is recorded, the memory card can be removed from the recording device and inserted into a portable playback device, such as a computer, smart phone, or portable media player. This allows consumers to watch video content whenever they want and wherever they want.

### SUMMARY

The present invention is defined by the following claims, and nothing in this section should be taken as a limitation on those claims.

By way of introduction, the embodiments described below provide a video content recording apparatus with electronic program guide functionality. In one embodiment, a video content recording apparatus is disclosed comprising circuitry operative to receive electronic program guide data; operative to display, on a display device, an electronic program guide that uses the electronic program guide data; and operative to record, onto a removable memory device, video content selected using the electronic program guide. The electronic program guide data can be received from a removable memory device. In another embodiment, a video content recording apparatus is disclosed comprising circuitry operative to receive a scheduled recording file from a removable memory device and further operative to record, onto a removable memory device, video content specified in a scheduled recording file. Other embodiments are disclosed, and each of the embodiments can be used alone or together in combination.

The embodiments will now be described with reference to the attached drawings.

### BRIEF DESCRIPTION OF THE DRAWINGS

FIG. 1 is an illustration of a system of an embodiment for video content recording.

FIG. 2 is an illustration of an operation of a video content recording system of an embodiment.

FIG. 3 is a block diagram of a video content recording apparatus of an embodiment.

FIG. 4 is a display screen of a graphical user interface of an embodiment that facilitates scheduling a recording.

FIG. 5 is a display screen of an electronic program guide of an embodiment that allows a user to browse available video content by genre, channel, or title.

FIG. 6 is a display screen of an electronic program guide of an embodiment that allows a user to browse available video content by genre.

FIG. 7 is a display screen of an electronic program guide of an embodiment that allows a user to browse available video content by channel.

FIG. 8 is a display screen of an electronic program guide of an embodiment that allows a user to browse available video content by title.

FIG. 9 is an illustration of an embodiment that can be used to provide electronic program guide data to a video content recording apparatus.

FIG. 10 is an illustration of another embodiment that can be used to provide electronic program guide data to a video content recording apparatus.

### DETAILED DESCRIPTION OF THE PRESENTLY PREFERRED EMBODIMENTS

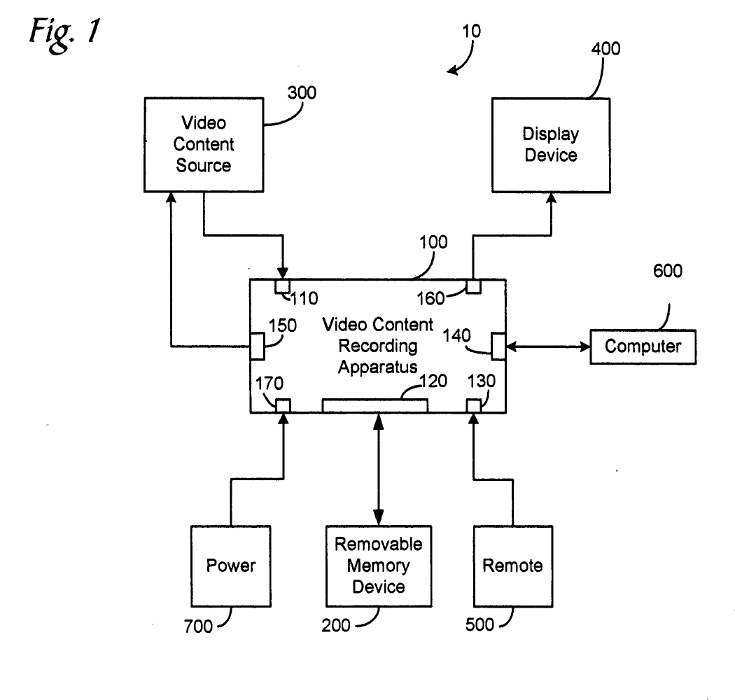

Turning now to the drawings, FIG. 1 is an illustration of a system 10 of an embodiment for recording video content. Video content can take any suitable form. In many situations, video content contains moving images; however, in some situations, video content can contain one or more still images. Examples of video content include, but are not limited to, a cable television broadcast, a satellite television broadcast, a terrestrial (i.e., “over-the-air”) television broadcast, or a video output from a VCR, DVD player, camcorder, camera/video phone, personal or digital video recorder (e.g., TiVo™), game player, or personal computer (e.g., an Internet broadcast). Video content can be in analog or digital form and converted from one form to another.

Video content is most often, but not always, associated with audio content that is played in a synchronized fashion with the video content. To simplify the discussion of these embodiments, audio content will not be treated in as much detail as video content. It should be kept in mind, however, that when an action or element is described in the following description and claims solely in the context of video content, no assumptions should be made regarding whether or not that action or element also relates to audio content. For example, when it is said that video content is recorded and played back, no assumption should be made as to whether or not audio content is also being recorded and played back.

Referring back to FIG. 1, the system 10 comprises a video content recording apparatus 100, a removable memory device 200, a video content source 300, a display device 400, a remote control device 500, a computer 600 and a power supply 700. The video content recording apparatus 100 will be described in more detail below.

A “removable memory device” refers to a storage device that can be placed in/on and removed from the video content recording apparatus 100. A removable memory device 200 can take any suitable form, and it is presently preferred that the removable memory device 200 take the form of a non-volatile, solid-state memory device, such as a flash memory card. Memory cards of a particular type typically conform to a standard size and format and are interchangeable in the sense that they can be inserted and removed from a variety of host devices. Suitable flash memory cards include, but are not limited to, the following memory cards: SD™, SD™(HC), MiniSD™(HC), MMC™, MMCplus™, MMCmobile™, MicroSD™(HC), Memory Stick™, Memory Stick PRO™, Memory Stick Duo™, and Memory Stick PRO Duo™. A USB memory device can also be used. Any suitable type of memory array can be used in a solid-state memory device, including a write-many or write-once two-dimensional or three-dimensional array, made from any suitable material. While it is presently preferred that the removable memory device 200 be a solid-state memory device, other removable memory devices can be used, such as, but not limited to, an optical disc and a magnetic disk.

A video content source 300 is any device that provides video content. Examples of a video content source include, but are not limited to, a cable tuner box, a satellite tuner box, a digital video broadcasting (DVB) tuner box, a terrestrial antenna, a set-top box, a VCR, a DVD player, a camcorder, a digital camera, a camera/video phone, a personal or digital video recorder (e.g., TiVo™), a game player, or a personal computer. The video content source 300 can provide video content in analog or digital form. A display device 400 can be a monitor or television, for example. In some situations, the video content source 300 is part of the display device 400, such as when the display device 400 is a television with a built-in tuner. The remote control device 500 is typically a wireless handheld user interface device used to communicate user commands to the video content recording apparatus 100. The computer 600 can be any suitable computing device, and the power supply 700 can be AC or a battery or both.

As shown in FIG. 1, the video content recording apparatus 100 comprises a variety of inputs and outputs to place the video content recording apparatus 100 in communication with other components. It should be noted that the video content recording apparatus 100 can contain additional or different inputs and outputs. It should also be noted that even though the term “input” and “output” are used and one-way arrows are sometimes used in the drawings, in some situations, there can be two-way communication between the video content recording apparatus 100 and the component connected via the input/output. Also, any suitable type of input or output can be used, and the terms input and output should be not restricted to the examples set forth in this description. Further, while the inputs and outputs are described herein as “first input,” “first output,” “second input,” etc., the first and second inputs (or outputs), for example, are not necessarily the same type of inputs (or outputs) just because the word “input” (or “output”) is used. For example, one input can be a physical connector, while another input can be an infrared receiver.

The video content recording apparatus 100 comprises a first input 110 configured to receive video content from the video content source 300. Although any suitable input can be used, it is presently preferred that the first input be a composite video input. Composite video combines the three basic elements of a video picture (color, brightness, and synchronization data) into a single combined signal and is commonly used in consumer video equipment. The video content recording apparatus 100 also comprises a second input 120 configured to receive the removable memory device 200. When the removable memory device 200 takes the form of a memory card, the second input 120 can be a slot in the video content recording apparatus 100 that contains an electrical connector that mates with a mating connector on the memory card. The second input 120 can be adapted for any suitable removable memory device (e.g., the second input 120 can be a tray for receiving an optical disc). Although only a single second input 120 is shown in FIG. 1, it should be understood that the video content recording apparatus 100 can contain inputs for a plurality of removable memory devices of the same type or of different types.

The video content recording apparatus 100 further comprises a third input 130 configured to receive user input. As shown in FIG. 1, the third input 130 can be configured to receive a communication from the remote 500. For example, the third input 130 can be an infrared receiver that receives infrared transmissions from the remote 500; however, other inputs can be used (e.g., a physical connector if the remote 500 is wired to the video content recording apparatus 100 with an electrical or optical cable). The third input 130 can also be one or more buttons or other types of user interface elements on the apparatus 100 itself. As yet another alternative, the third input 130 can comprise both user interface elements on the apparatus 100 itself as well as be configured to receive a communication from the remote 500. In other words, the third input 130 can take any form to allow a user to provide input to the apparatus 100 where some or all of the user interface elements (e.g., buttons, switches, etc.) can be on the remote 500 or on the apparatus 100 itself (or any other component). In this way, all of the user interface elements can be on the remote 500, all of the user interface elements can be on the apparatus 100 itself, or there can be a mix of user interface elements on the remote 500 and the apparatus 100 itself.

The video content recording apparatus 100 also comprises a fourth input 140 configured to allow the apparatus 100 to be connected to the computer 600. It is presently preferred that the fourth input 140 be a USB connector. Although not shown, the video content recording apparatus 100 can comprise inputs (e.g., left and right channels) for audio content.

The video content recording apparatus 100 also has a number of outputs, such as the first output 150 that is configured to provide control information to the video content source 300. The first output 150 is preferably an infrared emitter that communicates control information to the video content source 300 via an infrared transmission, although other wireless technologies can be used. As an alternative to using wireless technology, the first output 150 can be physically connected to the video content source 300, e.g., via an electrical or optical cable. The second output 160 is configured to provide video content and other display output (e.g., a graphical user interface) to the display device 400 and is preferably a composite video output and, optionally, an HDTV output. The power input 170 receives power from the power supply 700. Although not shown, the video content recording apparatus 100 can comprise outputs (e.g., left and right channels) for audio content.

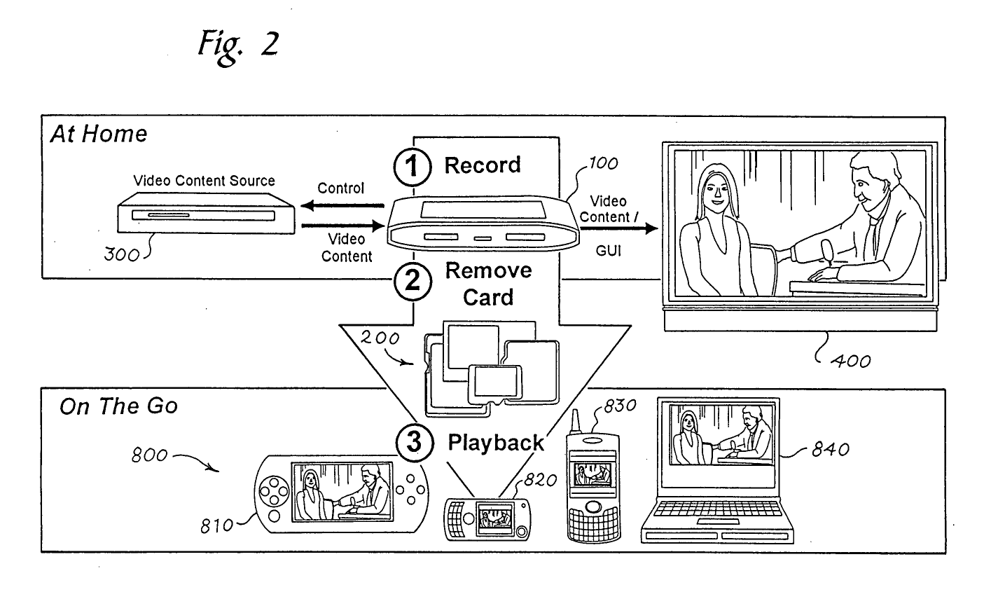

FIG. 2 illustrates the operation of one embodiment of the video content recording system 10. In this embodiment, the video content recording apparatus 100 takes the form of a “video memory card recorder,” and the removable memory device 200 takes the form of a flash memory card. (As shown in FIG. 2, the video memory card recorder has a plurality of card slots to support different types of memory cards.) The video content recording apparatus 100 has similar recording and playback functionality as a video cassette recorder (“VCR”) but uses flash memory cards instead of VCR tapes.

As shown in FIG. 2, the first step is for the video content recording apparatus 100 to record video content from the video content source 300 directly onto the removable memory device 200. (In an alternate embodiment, the video recording apparatus 100 contains an additional storage device (or an existing storage device that is otherwise used for a different purpose) that allows video content to be stored (temporarily, as in a cache, or otherwise) before recording it onto the removable memory device.) If the recording is a scheduled recording, the video content recording apparatus 100 sends control information via the first output 150, e.g., an IR emitter, (see FIG. 1) to turn on the video content source 300 and select a channel. As with a VCR or a DVR, the scheduled recording can be based on channel, date, and start/stop times, including daily and weekly repeats. The video content recording apparatus 100 can display a graphical user interface (“GUI”) on the display device 400 to provide an easy way for a user to schedule a recording, as well as to playback video content and change settings. During the recording of the video content onto the removable memory device 200, the video content recording apparatus 100 can also display the video content on the display device, either in real-time or otherwise, such as when the user “pauses” and then resumes watching a live broadcast. The video content recording apparatus 100 can also have additional functionality, such as, but not limited to, playing back and archiving digital photos, playing back audio files, and, as described in more detail below, acting as a card reader for a computer.

After the recording, the user removes the removable memory device 200 from the video content recording apparatus 100 and inserts it into a playback device 800 for playback. A playback device can be any video-enabled device, such as but not limited to, a handheld game console 810 (e.g., the Sony PSP™ or the Nintendo DS™), a mobile phone 820, a smart phone 830, a PC/notebook computer 840, a portable media player, such as a SanDisk Sansa™ e200 Series MP3 player, a handheld computer or other video-enabled device (including, but not limited to, a Windows CE device), a set-top box, or a display device (e.g., a television) with playback functionality. A playback device can also be the same (or different) video content recording apparatus 100 that recorded the video content onto the removable memory device 200. Accordingly, as described in more detail below, video content can be recorded on the removable memory device 200 in a format that is both suitable for small screen sizes of portable playback devices as well as full-screen sizes of display devices:

As can be seen from the examples noted above, a playback device can perform functions in addition to playing back video content stored on the removable memory device 200. For example, the playback device can also play games, make telephone calls, receive email, or even record video content. Also, while it would be especially convenient for the playback device to contain an input for the removable memory device 200 (e.g., a memory card slot), so the user can just “plug in” the removable memory device 200 into the playback device, some playback devices may not contain such an input, such as some existing portable media players, or may not have an input for the type of memory device (e.g., memory card) used by the video content recording apparatus 100. In these situations, the user can transfer the video content from the removable memory device 200 first to an intermediary device, such as a personal computer 840, and then from the intermediary device to the ultimate playback device (e.g., using software on the intermediary device).

As can be seen from the illustration in FIG. 2, the video content recording apparatus 100 allows a user to store and watch video content when he wants and wherever he wants (e.g., on the road, during a commute, at a friend's house, etc.). By using the removable memory device 200 as a transport medium for video content, the video content recording apparatus 100 frees the user from the static viewing environment of his home. Also, unlike some existing DVRs that achieve video content portability by requiring a user to transfer the video content from the DVR to a personal computer, the video content recording apparatus 100 records the video content directly onto the removable media device 200 without requiring a personal computer. Using a removable media device 200 to provide video content to a playback device is also faster and less expensive than subscribing to pricey wireless video services for mobile phones and avoids the uncertainty of whether a wireless connection will be present while a user is roaming. Further, since solid-state memory devices, such as flash cards, can store video content more reliably and for a longer time than videocassette tapes, the video content recording apparatus 100 also provides the advantage of being able to archive precious video content on a more durable medium.

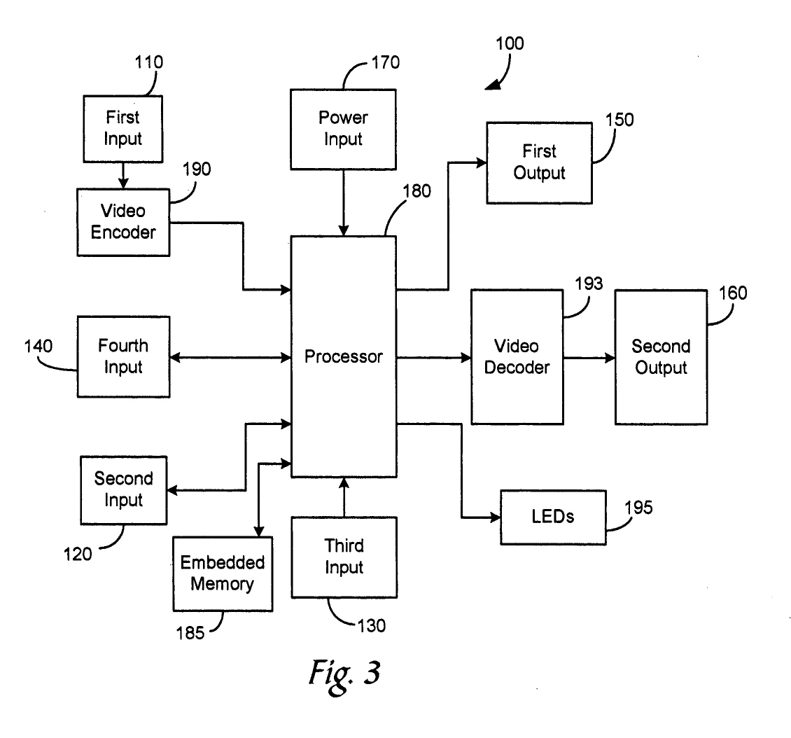

Returning to the drawings, FIG. 3 is a block diagram of the some of the components of the video content recording apparatus 100 of an embodiment. It should be noted that the video content recording apparatus 100 can contain additional or different components than the ones shown in FIG. 3. Also, it is presently preferred that the various inputs, outputs, and components be carried by a housing (an input or output protruding from the housing is still “carried by” the housing). In an alternate embodiment, one or more of the various inputs, outputs, and components are distributed among two or more housings.

As shown in FIG. 3, in addition to the inputs and outputs shown in FIG. 1, the video content recording apparatus 100 comprises a processor 180, embedded memory 185 (e.g., EEPROM or NAND memory), a video encoder 190, a video decoder 193, and LEDs 195. The LEDs can contain a power LED to indicate that the apparatus 100 is on/off, a removable memory device LED to indicate that a removable memory device is recognized/present and ready for transmission, a transmission LED that blinks when data is being transferred, and a recording/warning LED that is on during recording and blinks when there is not enough storage space on the removable memory device or when no removable memory device is present when recording is requested. In one embodiment, an LED is used next to the second input 120 to both indicate the presence of the memory device 200 (e.g., when the LED is continuously on) and to indicate data transfer (e.g., when the LED is blinking).

With reference now to both FIGS. 1 and 3, in operation, based on a recording request, the processor 180 sends control information via the first output 150 to the video content source 300 to turn on the video content source 300 and select a channel. The video content provided by the video content source 300 is sent to the video encoder 190. In this embodiment, the video content is outputted as an analog signal from the video content source 300, and the video encoder 190 converts the analog signal to a digital signal and provides the digital signal to the processor 180. (The video decoder 193 is used for the reverse operation—to convert the digital signal provided by the processor 180 to an analog signal used by the display device 400.) The processor 180 processes the digital signal and records it (preferably, in a compressed format) on the removable memory device 200. Because playback devices vary in video/audio codec support, file format support, screen resolution/orientation, frame rate, bit rate, video processing, card format support, and folder name/structure, it is preferred that the video content recording apparatus 100 know these video content recording parameters upfront in order to create the appropriate video content file and record it in such a way on the removable memory device 200 to make the video content compatible with a target playback device. As used herein, the term “video content recording parameter” refers to a parameter used in recording video content. Examples of a video content recording parameter include, but are not limited to, a video codec parameter, an audio codec parameter, a file format parameter, a file wrapper parameter, frame rate (e.g., frames per second), video bit rate, audio bit rate, audio bit rate variation, a video processing parameter, screen resolution, screen orientation, card format, folder structure, and folder name.

In this embodiment, video content recording parameters (and values for those parameters) for a plurality of playback devices are stored in a database in the firmware stored in the embedded memory 185. In operation, a user selects a target playback device (such as a mobile phone or a handheld game device) using the remote control device 500 and a graphical user interface displayed on the display device 400. After the user makes a selection, the processor 180 selects the corresponding video content recording parameter (and associated values) for that playback device from the database stored in the firmware. The processor 180 then processes and records the video content in the removable media device 200 in accordance with the values of those parameters. Additional information about the use of video content recording parameters and mechanisms for updating video content recording parameters can be found in “Video Content Recording Apparatus with Syntax for Video Content Recording Parameters,” U.S. patent application Ser. No. 11/514,651, filed Sep. 1, 2006, and “Method for Using a Video Content Recording Apparatus with Syntax for Video Content Recording Parameters,” U.S. patent application Ser. No. 11/514,471, filed Sep. 1, 2006, both of which are assigned to the assignee of the present invention and are hereby incorporated by reference.

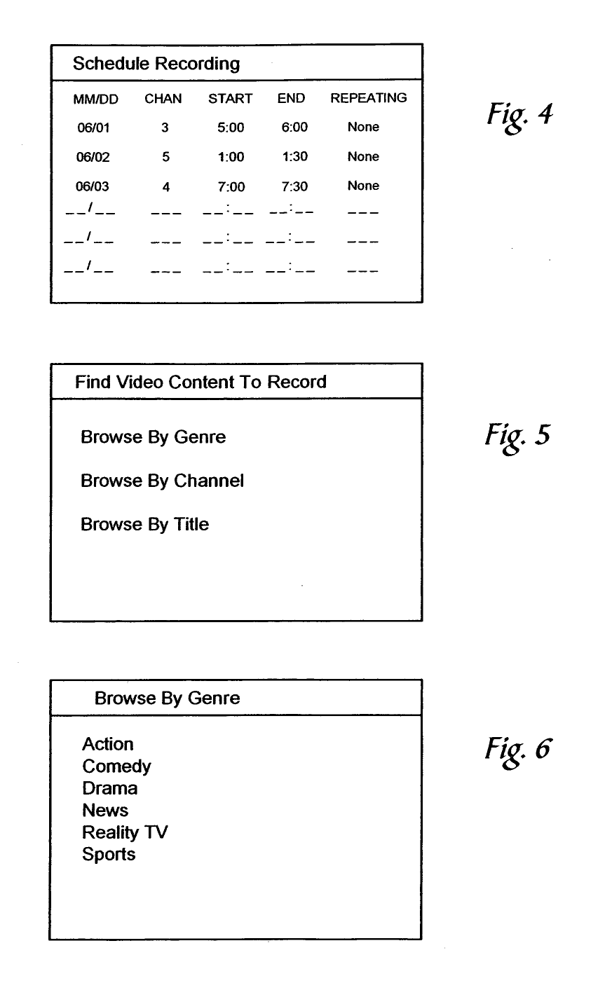

As mentioned above, the video content recording apparatus 100 allows a user to schedule a recording. FIG. 4 is a display screen of a graphical user interface of an embodiment that facilitates scheduling a recording. In this embodiment, a user schedules a recording by manually entering the date, channel, and start/end times of the desired recording, including the option of repeats (e.g., daily or weekly) using, for example, user interface elements (e.g., buttons, switches, etc.) on the remote 500 or on the apparatus 100 itself. The user can learn of the date, channel, and start/end times of the desired recording by-consulting program schedule information in a print or electronic TV guide (e.g., in the newspaper, on a website, or a guide channel).

In another embodiment, the video content recording apparatus 100 provides an electronic program guide to facilitate user selection of a desired recording. An electronic program guide (or “EPG”) is a displayed user interface that provides information about current and/or upcoming video content to allow a user to select a desired recording. Unlike the technique shown in FIG. 4, with an EPG, a user does not need to know the date, channel, time, or even the title of the desired video content. An EPG allows a user to select a desired recording by navigating through a list of upcoming programs, which can be filtered based on, for example, genre, channel name or number, title, broadcast date, start/end times, parental control information, actors, directors, year of production, and keywords included in a synopsis or other descriptive information about the video content.

FIGS. 5-8 are examples of display screens of an exemplary EPG. It should be noted that these display screens are merely examples and that the following claims should not be limited to the functionality shown in these display screens. FIG. 5 is a display screen of an EPG that allows a user to browse available video content by genre, channel, or title. When a user chooses to browse by genre, a different display screen is provided that lists various genres (see FIG. 6). When the user selects a particular genre, titles of video content in that genre are displayed to the user for selection. For example, if the user selects Comedy, the EPG can display the titles of programs that are classified in the EPG as comedies. The user then selects one of the listed programs to record.

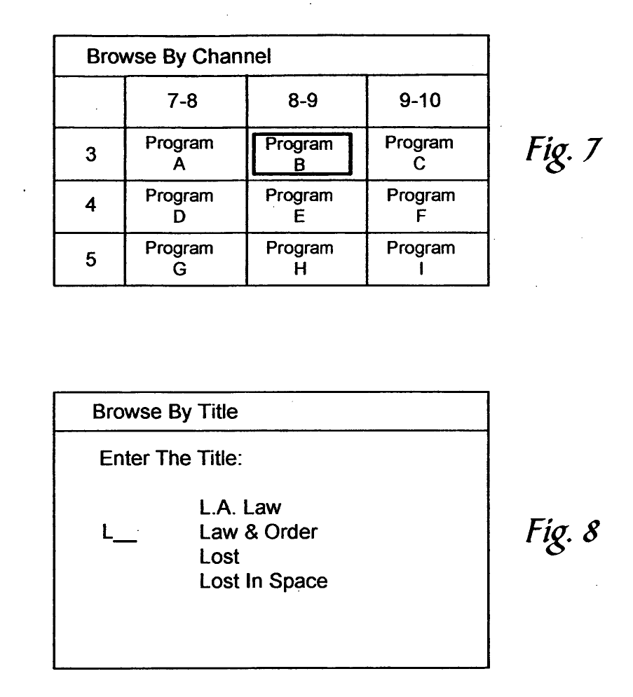

When a user chooses to browse by channel, a different display screen is provided that allows a user to browse by channel (see FIG. 7). A grid-like structure is displayed, with the left-most column of the grid representing channels, and the top-most row of the grid representing time slots. A user would select a desired program by navigating a movable cell over the desired program in the grid.

When a user chooses to browse by title, a different display screen is provided that allows a user to enter the title of the video content he would like to record (see FIG. 8). The user can input the characters of a desired title using, for example, user interface elements on the remote 500 or the apparatus 100 itself. To assist the user in finding the video content, the EPG can list various video content that matches the entered characters as they are being entered. For example, as shown in FIG. 8, when the user inputs the letter “L,” various shows that start with the letter “L” are displayed for selection. As the user inputs additional letters, the list can change accordingly. As another example, an entire list of available video content can be displayed, and, as a user types-in or scrolls to a letter, a selection bar or cursor can jump to that section in the list. The advantage of showing the entire list of video content is that it gives a user the opportunity to recognize and select video content instead of spontaneously coming up with a program name. As mentioned above, the display screens shown in FIGS. 5-8 are merely examples, and other EPG functionality can be used. For example, the EPG can display descriptive information of video content, such as a synopsis, list of actors, year of production, parental control information, etc.

With reference to FIG. 3, in one embodiment, the computer-readable program code used to provide the EPG is stored in the embedded memory 185 and is executed by the processor 180. This computer-readable program code will be referred to herein as the “EPG application” (or “EPG client”). When the EPG application is executed by the processor 180, it provides a graphical user interface on the display device 400 to facilitate user selection of a desired recording. The EPG application presents EPG data to a user and processes and translates user input (e.g., selection of video content) into commands/instructions for the video content recording apparatus 100 to record the selected video content. As used herein, “EPG data” broadly refers to any information about video content that can be used to facilitate user selection of a desired recording. EPG data includes, but is not limited to, broadcast date, channel number, channel name, start/end times, as well as descriptive information about video content, such as, but not limited to, title, synopsis, actors, directors, year of production, genre, parental control information, and duration. An EPG data file can be limited, e.g., from a time perspective (e.g., only broadcast information available for a few weeks) or a size perspective (e.g., certain maximum file size the apparatus 100 can handle).

In order to keep the EPG up-to-date, new EPG data is supplied to the video content recording apparatus 100. The EPG data can be supplied to the video content recording apparatus 100 in any desired manner. For example, the video content recording apparatus 100 can contain a phone jack and functionality to periodically place an outgoing phone call to a computer server to download new EPG data. Alternatively, if the video content recording apparatus 100 is connected (directly or indirectly through a computer) to a network, such as the Internet, new EPG data can be downloaded using the computer. However, in this embodiment, the video content recording apparatus 100 is designed as a stand-alone add-on component to a home entertainment system and does not require direct connection to a network. Accordingly, there is a need for a mechanism to provide EPG data to the video content recording apparatus 100.

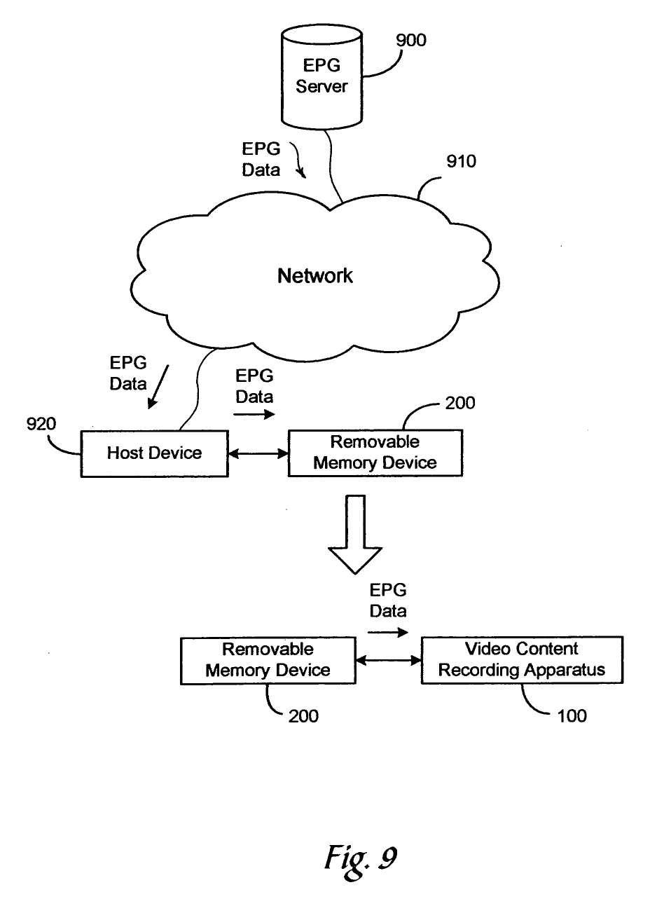

Turning again to the drawings, FIG. 9 is an illustration of an embodiment that can be used to provide EPG data to the video content recording apparatus 100. As shown in FIG. 9, an EPG server 900 storing EPG data is in communication with a network 910, which is in communication with a host device 920. As used herein, one component is “in communication with” another component through any suitable medium, and the communication can be one way or two way. Also, although a line is shown as connecting the components in the drawings, it should be understood that a wired connection is not needed and that a wireless connection (e.g., RF, IR, etc.) can be used. As also used herein, a “network” can take any suitable form, such as a telephone network, a computer network (e.g., the Internet, an intranet, an extranet, etc), or any combination thereof (e.g., the Internet connected to a cellular telephone network). The host device 920 is any device that has an input for receiving the removable memory device 200 and is operative to communicate with the EPG server in any suitable manner. Examples of a host device include, but are not limited to, a PC/notebook computer, a handheld game console, a mobile phone, a smart phone, a portable media player, and a handheld computing device. A host device can be a wireless or wired device.

In operation, a user inserts the removable memory device 200 (e.g., a memory card or a USB flash drive (“UFD”)) into the host device 920 or into an apparatus attached to the host device 920, such as a memory card reader (which, as described above, can be the video content recording apparatus 100). The user then uses the host device 920 to connect to the EPG server 900, e.g., to view a web site provided by the EPG server 900. (Although not necessary, the web site could be supported by the manufacturer of the video content recording apparatus 100.) Using the website (which can be limited to just one or a few pages), the user downloads the EPG data from the EPG server 900 and stores it on the removable memory device 200. The user then removes the removable memory device 200 from the host device 920 and inserts it into the video content recording apparatus 100. The EPG data is then transferred from the removable memory device 200 and stored in the video content recording apparatus 100. (EPG data can also be processed from the removable memory device 200 instead of transferring/copying to the EPG application or embedded memory.) The video content recording apparatus 100 can record video content in the same memory device that provided the EPG data or in a different memory device. As another alternative, instead of a user downloading EPG data, EPG data can be distributed on a memory card (e.g., a television guide on a flash memory card).

Preferably, the EPG data is stored using a specific file format/extension that can be recognized by the video content recording apparatus 100. In this way, similar to a firmware upgrade, when the user inserts the removable memory device 200 into the video content recording apparatus 100, the processor 180 can automatically recognize the EPG data file and compare it to EPG data that is currently loaded in the EPG application. (Alternatively, the user can manually load the EPG data from the removable memory device 200 to the video content recording apparatus 100.) If no EPG data is currently loaded in the EPG application or the currently-loaded EPG data is an older set of data, a message can be displayed on the display device 400 stating “New program guide data detected. Do you want to update the program guide?” After the user confirms, the new EPG data can be loaded into the embedded memory 185, and the user can access the updated EPG data. As the new EPG data is only for a limited amount of time (e.g., the next two-four weeks), the user would repeat the above process when new EPG data is needed. More generally, the user has three options: (1) replace the existing EPG data with data from an EPG data file, (2) add information from an EPG data file to existing data, and (3) compare the existing EPG data with the new EPG data and add only the new entries to the existing EPG data. Additionally, a message can be displayed reminding the user to load a new EPG data file on X day or in X days.

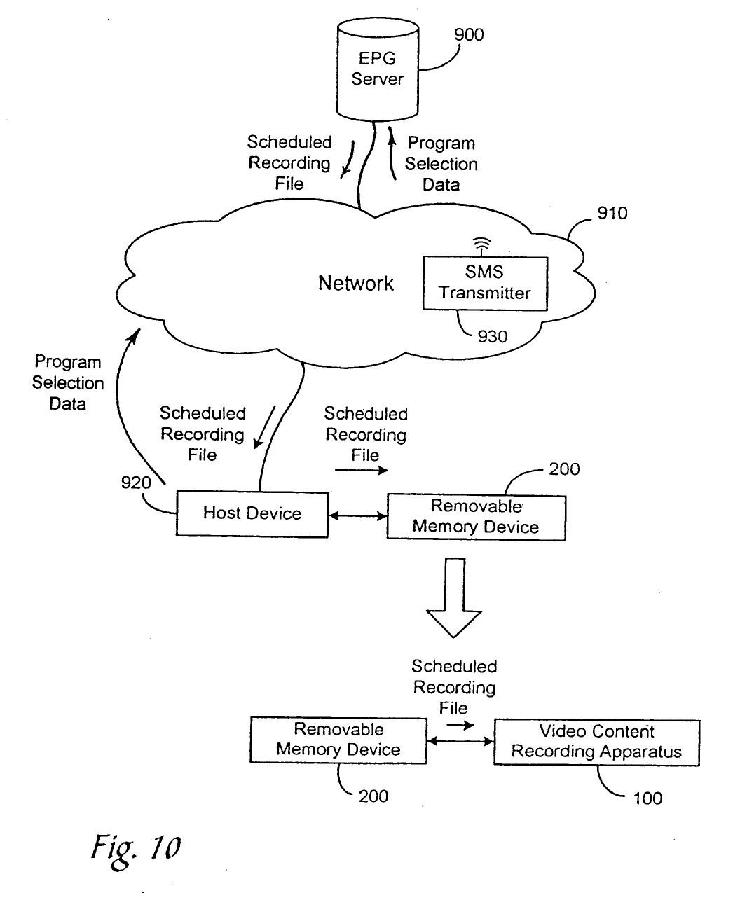

Returning again to the drawings, FIG. 10 is an illustration of an alternate embodiment. As in the embodiment shown in FIG. 9, a user connects the removable memory device 200 to the host device 920 and uses the host device 920 to connect to the EPG server 900. However, in this embodiment, the web site provided by the EPG server 900 provides an electronic program guide, and the user selects which programs to record using the web site (instead of the video content recording apparatus 100). The web site with the EPG can be formatted to display in a user-friendly way on the host device 920, especially when the host device 920 has a smaller screen. For example, the host device 920 can be a mobile phone with an Internet connection and an input for a removable memory card. This allows a user to schedule recordings from his mobile phone when he is on-the-go. It should be noted that the EPG might not only be changed/customized based on smaller screen size but also based on a different processor (with less processing power), operating system, or browser.

Using the EPG on the web site, the user selects the program(s) he wants to record. After the selection, a scheduled recording file is downloaded from the EPG server 900 and saved in the removable memory card 200. Also, it is possible for a phone or other networked device (e.g., a PC) to have an EPG application to select programs for recording (as on the video content recording apparatus 100 itself). This application on the phone, PC, etc. can generate the scheduled recording file and store it on the removable memory device.

As used herein, a “scheduled recording file” is a file that contains information that instructs the video content recording apparatus 100 to record selected video content specified in the file. A “scheduled recording file” can contain, for example, the date, channel, and start/end times of the selected video content, as well as descriptive and other information, such as program name and synopsis, that can later be viewed by the user using the video content recording apparatus 100. There can be one data file with various schedule recording settings or one file for each schedule recording.

Preferably, the scheduled recording file is stored using a specific file format/extension that can be recognized by the video content recording apparatus 100. In this way, when the user inserts the removable memory device 200 into the video content recording apparatus 100, the processor 180 can automatically recognize the scheduled recording file and compare the information in the scheduled recording file with what is currently scheduled in the video content recording apparatus 100. (Alternatively, the user can manually load the scheduled recording file from the removable memory device 200 to the video content recording apparatus 100.) If no recording has been scheduled or the current scheduled recording(s) are different from what is specified in the scheduled recording file, a message can be displayed on the display device 400 saying “New recording schedule detected. Do you want to add?” After the user confirms, the recording schedule is loaded, and the video content recording apparatus 100 will record the program according to the settings in the scheduled recording file. If there are changes in the recording settings, the video content recording apparatus 100 can also display those changes with a message asking whether the user wants to load/install the new recording schedule.

In another alternative, instead of downloading the scheduled recording file from the EPG web site, the scheduled recording file can be sent from the EPG server 900 to the host device 920 as a message. This is especially convenient if the host device 920 is a mobile phone. For example, the scheduled recording file can be sent as a a short message service (SMS) message (e.g., a multimedia SMS message) using an SMS transmitter 930 in the network 930. After the host device 920 receives the scheduled recording file, the user can store the scheduled recording file on the removable memory device 200, remove the removable memory device 200 from the host device 920, and insert it into the video content recording apparatus 100. Network providers may prefer this alternative, as they can charge for each message that is sent and/or received. As another alternative, an EPG data file or scheduled recording settings can be e-mailed in an attachment.

Other alternatives and embodiments can be used with the embodiments described herein. For example, data in addition to EPG data and/or a scheduled recording file can be downloaded or sent in a message to the host device. Further, instead of the user downloading the EPG data onto a removable memory device, a removable memory device pre-loaded with EPG data can be distributed to a user. Also, as noted above, the video-content recording apparatus can received electronic program guide data without the use of a removable memory device storing the data. For example, the video content recording apparatus can receive electronic program guide data from a storage device in communication with the video content recording apparatus over a network. Also, if EPG data is being sent with the video content to the video content source 300 (e.g., in the broadcast transport stream or in a separate data channel), the video content recording apparatus 100 can contain functionality to pull EPG data from the video content source 300.

As yet another example, a “recording profile” can be stored on a removable memory device that informs a video content recording apparatus of the video content recording parameters that are to be used with that removable memory device. In operation, when the removable memory device is inserted into the video content recording apparatus, the processor could recognize the recording profile by its file extension and then use the video content recording parameters specified in that file to record video content on that memory device. In this way, a user can insert a memory device into his or another's video content recording apparatus, and the apparatus would know how to record the video content consistent with the user's playback device without requiring any further action by the user. This is especially advantageous when a single video content recording apparatus is used by multiple users, such as in a multi-user household with different users having different playback devices. The video content recording apparatus would automatically record video content for a particular playback device without a user having to manually select a target playback device. More generally, the video content recording apparatus can be configured to (1) always let the recording profile override previous settings, (2) never let the recording profile override previous settings, or (3) let the recording profile override previous settings after confirmation by the user. In the event that the recording profile is used, the video content recording apparatus can be configured to return to its previous video content recording parameters after the removable memory device is removed from the apparatus.

In another alternative, the video content recording apparatus can have card-slot-specific recording. Additional information about this alternative can be found in “Video Content Recording Apparatus with Card-Slot-Specific Recording ,” U.S. patent application Ser. No. ______ (attorney docket no. 10519-155), filed herewith, and “Method for Using a Video Content Recording Apparatus with Card-Slot-Specific Recording,” U.S. patent application Ser. No. ______ (attorney docket no. 10519-165), filed herewith, both of which are assigned to the assignee of the present invention and are hereby incorporated by reference.

Finally, in the above embodiment, a processor and firmware were used to perform various functionality. Recognizing that there are alternatives to such an arrangement, the term “circuitry” is used as a more general descriptor for the one or more components that can be used to perform the operations discussed herein. For example, as above, “circuitry” can take the form of a processor executing computer-readable program code stored in a computer-readable medium (e.g., here, firmware stored in embedded memory). As noted above, the embedded memory can take the form of EEPROM or NAND memory, although other memory can be used. Also, computer-readable media other than embedded memory (such as, but not limited to, a hard drive, a removable memory device, etc.) can be used to store computer-readable program code. Accordingly, all or part of the computer-readable program code referred to herein as firmware can be software routines stored in embedded memory or in a storage device other than embedded memory. “Circuitry” can take other suitable forms, such as an application specific integrated circuit (ASIC), a programmable logic controller, an embedded microcontroller, and a single-board computer. Accordingly, the term “circuitry” should not be limited to any particular type of implementation, described herein or otherwise. Further, “circuitry” should not be limited to the functions described herein. For example, when circuitry takes the form of a processor executing firmware, as above, it should be understood that the processor can perform functions in addition to the ones described above.

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. A video content recording apparatus operative to record video content onto a removable memory device, the video content recording apparatus comprising:
a first input configured to receive video content;
a second input configured to receive a removable memory device; and
circuitry operative to receive electronic program guide data stored in a removable memory device; operative to display, on a display device, an electronic program guide that uses the electronic program guide data; and operative to record, onto a removable memory device, video content selected using the electronic program guide.

2. The video content recording apparatus of claim 1, further comprising firmware storing an electronic program guide application, wherein the electronic program guide data is stored as a file that is recognizable by the electronic program guide application as containing electronic program guide data.

3. The video content recording apparatus of claim 1, wherein the electronic program guide data comprises one or more of the following: broadcast date, channel number, channel name, start time, end time, title, synopsis, actor, director, year of production, genre, parental control information, and duration.

4. The video content recording apparatus of claim 1, wherein the removable memory device that stores the electronic program guide data is different from the removable memory device that the circuitry records video content onto.

5. The video content recording apparatus of claim 1, wherein the electronic program guide data is provided to the removable memory device via a host device.

6. The video content recording apparatus of claim 5, wherein the electronic program guide data is downloaded from a website using the host device.

7. A video content recording apparatus operative to record video content onto a removable memory device, the video content recording apparatus comprising:
a first input configured to receive video content;
a second input configured to receive a removable memory device; and
circuitry operative to receive a scheduled recording file from a removable memory device and further operative to record, onto a removable memory device, video content specified in a scheduled recording file.

8. The video content recording apparatus of claim 7, wherein the scheduled recording file is stored in a manner that makes it recognizable by the circuitry as being a scheduled recording file.

9. The video content recording apparatus of claim 7, wherein the scheduled recording file comprises one or more of the following: broadcast date, channel number, channel name, start time, end time, title, synopsis, actor, director, year of production, genre, parental control information, and duration.

10. The video content recording apparatus of claim 7, wherein the removable memory device that stores the scheduled recording file is different from the removable memory device that the circuitry records video content onto.

11. The video content recording apparatus of claim 7, wherein the scheduled recording file is provided to the removable memory device via a host device.

12. The video content recording apparatus of claim 11, wherein the scheduled recording file is downloaded from a website using the host device.

13. The video content recording apparatus of claim 7, wherein the scheduled recording file is provided to the removable memory device via a wireless device.

14. The video content recording apparatus of claim 13, wherein the wireless device comprises a mobile phone.

15. The video content recording apparatus of claim 13, wherein the scheduled recording file is provided to the removable memory device by sending a short message service (SMS) message to the wireless device.

16. A video content recording apparatus operative to record video content onto a removable memory device, the video content recording apparatus comprising:
a first input configured to receive video content;
a second input configured to receive a removable memory device; and
circuitry operative to receive electronic program guide data; operative to display, on a display device, an electronic program guide that uses the electronic program guide data; and operative to record, onto a removable memory device, video content selected using the electronic program guide.

17. The video content recording apparatus of claim 16, wherein the video content recording apparatus receives the electronic program guide data from a removable memory device storing the electronic program guide data.

18. The video content recording apparatus of claim 16, wherein the video content recording apparatus receives the electronic program guide data from a storage device in communication with the video content recording apparatus over a network.
